(19) United States
(12) Patent Application Publication
(10) Pub. No.: US 2020/0357557 A1
(43) Pub. Date: Nov. 12, 2020

(54) MULTILAYER COIL COMPONENT

(71) Applicant: TDK CORPORATION, Tokyo (JP)

(72) Inventors: Yuto SHIGA, Tokyo (JP); Yoji TOZAWA, Tokyo (JP); Masaki TAKAHASHI, Tokyo (JP); Takashi ENDO, Tokyo (JP); Hajime KATO, Tokyo (JP)

(73) Assignee: TDK CORPORATION, Tokyo (JP)

(21) Appl. No.: 16/854,303

(22) Filed: Apr. 21, 2020

(30) Foreign Application Priority Data
May 7, 2019 (JP) 2019-087803

(51) Int. Cl. H01F 17/00; H01F 27/29

(52) U.S. Cl. CPC H01F 17/0013; H01F 27/292

(57) ABSTRACT

A multilayer coil component 1 includes an element body 2 having a plurality of stacked insulator layers 6 and having an outer surface provided with recessed portions 7 and 8, a coil 9 disposed in the element body 2, and terminal electrodes 4 and 5 connected to the coil 9 and disposed in the recessed portions 7 and 8. The recessed portions 7 and 8 are defined by a bottom surface and a side surface extending in a depth direction of the recessed portions 7 and 8 over the outer surface and the bottom surface, the terminal electrodes 4 and 5 have a first surface facing the bottom surface and a second surface facing the side surface, and a connection region A where a compound of elements constituting the element body 2 and a metal component are mixed is exposed to the second surface.

### TECHNICAL FIELD

The present invention relates to a multilayer coil component.

### BACKGROUND

The multilayer coil component that is described in, for example, Patent Literature 1 (Japanese Unexamined Patent Publication No. 2017-73536) is known as a multilayer coil component of the related art. The multilayer coil component described in Patent Literature 1 includes an element body, a coil disposed in the element body, and a pair of terminal electrodes embedded in a recessed portion of the element body and disposed over an end surface and a mounting surface of the element body.

### SUMMARY

In a configuration in which a terminal electrode is embedded in a recessed portion of an element body as in the multilayer coil component of the related art, the adhesion part between a side surface of the recessed portion and the terminal electrode is likely to be a starting point of peeling. Accordingly, when peeling occurs at the adhesion part between a side surface of the recessed portion and the terminal electrode in the multilayer coil component of the related art, peeling may serially occur at other contact parts. As a result, in the multilayer coil component of the related art, the terminal electrode may peel off from the element body.

An object of one aspect of the present invention is to provide a multilayer coil component with which peeling of a terminal electrode can be suppressed.

A multilayer coil component according to one aspect of the present invention includes an element body having a plurality of stacked insulator layers and having an outer surface provided with a recessed portion, a coil disposed in the element body, and a terminal electrode connected to the coil and disposed in the recessed portion. The recessed portion is defined by a bottom surface and a side surface extending in a depth direction of the recessed portion over the outer surface and the bottom surface, the terminal electrode has a first surface facing the bottom surface and a second surface facing the side surface, and a connection region where a compound of elements constituting the element body and a metal component are mixed is exposed to the second surface.

In the multilayer coil component according to one aspect of the present invention, the connection region where a compound of elements constituting the element body and a metal component are mixed is exposed on the second surface of the terminal electrode. In this manner, in the multilayer coil component, the surface of the terminal electrode that comes into contact with the side surface of the recessed portion of the element body contains a compound of elements constituting the element body, and thus the adhesion strength between the connection region and the element body is improved. Accordingly, in the multilayer coil component, the adhesion strength between the recessed portion of the element body and the second surface of the terminal electrode is improved. Accordingly, in the multilayer coil component, it is possible to suppress the occurrence of peeling at the adhesion part between the side surface of the recessed portion of the element body and the terminal electrode. As a result, peeling of the terminal electrode can be suppressed in the multilayer coil component.

In one embodiment, the connection region may be exposed to the second surface positioned in both end portions of the terminal electrode in a direction in which the plurality of insulator layers are stacked. In this configuration, the adhesion strength between the second surface positioned in both end portions of the terminal electrode and the element body is improved. Accordingly, peeling of the terminal electrode can be further suppressed in the multilayer coil component.

In one embodiment, the connection region may be exposed to the first surface. In this configuration, the adhesion strength between the element body and the first surface of the terminal electrode as well as the adhesion between the element body and the second surface is improved. Accordingly, peeling of the terminal electrode can be further suppressed in the multilayer coil component.

According to one aspect of the present invention, peeling of a terminal electrode can be suppressed.

### BRIEF DESCRIPTION OF THE DRAWINGS

FIG. 1 is a perspective view of a multilayer coil component according to a first embodiment.

FIG. 2 is an exploded perspective view of an element body of the multilayer coil component of FIG. 1.

FIG. 3 is a perspective view of the element body.

FIG. 4 is a cross-sectional view illustrating the configuration of the multilayer coil component.

FIG. 5A is a perspective view of a terminal electrode.

FIG. 5B is a perspective view of the terminal electrode.

FIG. 6 is a cross-sectional view illustrating the configuration of a multilayer coil component according to a second embodiment.

FIG. 7A is a perspective view of a terminal electrode.

FIG. 7B is a perspective view of the terminal electrode.

FIG. 8 is an exploded perspective view of the element body of the multilayer coil component of FIG. 6.

FIG. 9 is a cross-sectional view illustrating the configuration of a multilayer coil component according to a third embodiment.

FIG. 10A is a perspective view of a terminal electrode.

FIG. 10B is a perspective view of the terminal electrode.

FIG. 11 is an exploded perspective view of the multilayer coil component of FIG. 9.

### DETAILED DESCRIPTION

Hereinafter, preferred embodiments of the present invention will be described in detail with reference to the accompanying drawings. It should be noted that the same or equivalent elements will be denoted by the same reference numerals and redundant description will be omitted in the description of the drawings.

### First Embodiment

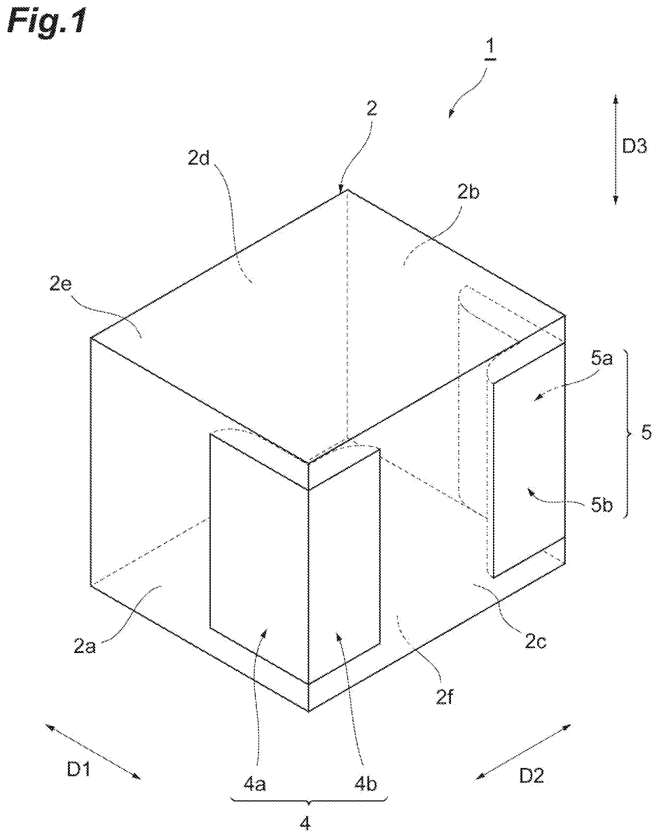

As illustrated in FIG. 1, a multilayer coil component 1 is provided with an element body 2 having a rectangular parallelepiped shape and a pair of terminal electrodes 4 and 5. The pair of terminal electrodes 4 and 5 are respectively disposed in both end portions of the element body 2. The rectangular parallelepiped shape includes a rectangular parallelepiped shape in which a corner portion and a ridge line portion are chamfered and a rectangular parallelepiped shape in which a corner portion and a ridge line portion are rounded.

The element body 2 has a pair of end surfaces 2a and 2b facing each other, a pair of main surfaces 2c and 2d facing each other, and a pair of side surfaces 2e and 2f facing each other. The direction in which the pair of main surfaces 2c and 2d face each other, that is, the direction that is parallel to the end surfaces 2a and 2b is a first direction D1. The direction in which the pair of end surfaces 2a and 2b face each other, that is, the direction that is parallel to the main surfaces 2c and 2d is a second direction D2. The direction in which the pair of side surfaces 2e and 2f face each other is a third direction D3. In the present embodiment, the first direction D1 is the height direction of the element body 2. The second direction D2 is the longitudinal direction of the element body 2 and is orthogonal to the first direction D1. The third direction D3 is the width direction of the element body 2 and is orthogonal to the first direction D1 and the second direction D2.

The pair of end surfaces 2a and 2b extend in the first direction D1 so as to interconnect the pair of main surfaces 2c and 2d. The pair of end surfaces 2a and 2b also extend in the third direction D3, that is, the short side direction of the pair of main surfaces 2c and 2d. The pair of side surfaces 2e and 2f extend in the first direction D1 so as to interconnect the pair of main surfaces 2c and 2d. The pair of side surfaces 2e and 2f also extend in the second direction D2, that is, the long side direction of the pair of end surfaces 2a and 2b. The multilayer coil component 1 is, for example, solder-mounted on an electronic device (such as a circuit board and an electronic component). In the multilayer coil component 1, the main surface 2c constitutes a mounting surface facing the electronic device.

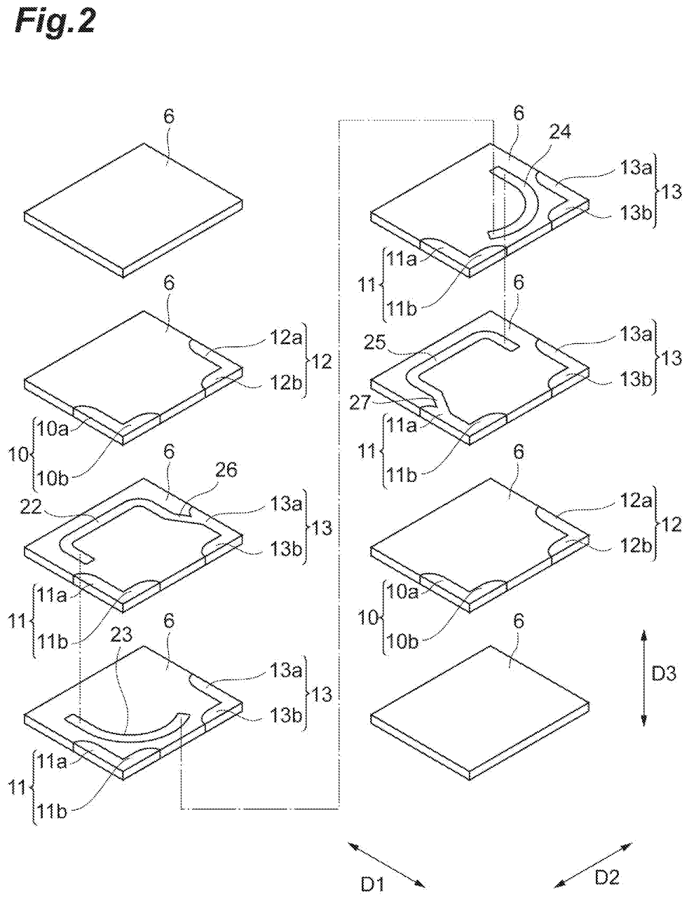

As illustrated in FIG. 2, the element body 2 is configured by a plurality of insulator layers 6 being stacked in the third direction D3. The element body 2 has the plurality of insulator layers 6 that are stacked. In the element body 2, the direction in which the plurality of insulator layers 6 are stacked coincides with the third direction D3. In the actual element body 2, each insulator layer 6 is integrated to the extent that the boundaries between the insulator layers 6 are invisible.

Each insulator layer 6 is formed of a dielectric material containing a glass component. In other words, the element body 2 contains a dielectric material containing a glass component as a compound of elements constituting the element body 2. The glass component is, for example, borosilicate glass. The dielectric material is, for example, BaTiO₃-based dielectric ceramic, Ba(Ti, Zr)O₃-based dielectric ceramic, or (Ba, Ca)TiO₃-based dielectric ceramic. A sintered body of a ceramic green sheet containing a glass ceramic material constitutes each insulator layer 6.

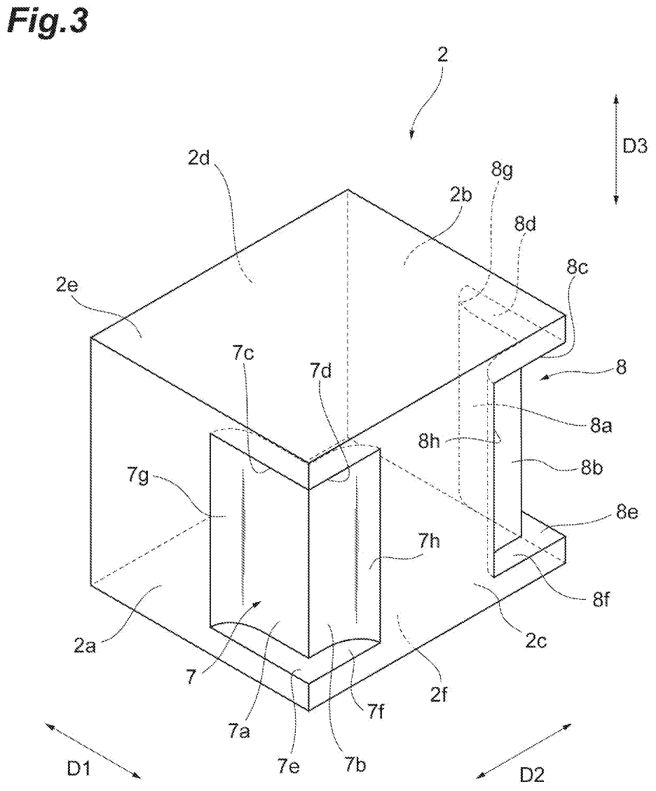

As illustrated in FIG. 3, the element body 2 has recessed portions 7 and 8. The recessed portion 7 is provided on the end surface 2a side of the element body 2. The recessed portion 7 is a space recessed inward from the outer surface of the element body 2. The recessed portion 7 has a shape corresponding to the shape of the terminal electrode 4. In the present embodiment, the recessed portion 7 has an L shape when viewed from the third direction D3. The recessed portion 7 is defined by bottom surfaces 7a and 7b and side surfaces 7c, 7d, 7e, 7f, 7g, and 7h. The bottom surface 7a extends along the first direction D1 and the third direction D3. The bottom surface 7a is parallel to the end surfaces 2a and 2b. The bottom surface 7b extends along the second direction D2 and the third direction D3. The bottom surface 7b is parallel to the main surfaces 2c and 2d. The side surface 7c and the side surface 7e are disposed so as to face each other in the third direction D3. The side surface 7c and the side surface 7e extend in the depth direction of the recessed portion 7 over the end surface 2a of the element body 2 and the bottom surface 7a. The side surface 7c and the side surface 7e extend along the first direction D1. The side surface 7c and the side surface 7e also extend in the second direction D2 (depth direction). The side surface 7c and the side surface 7e are parallel to the side surfaces 2e and 2f. The side surface 7d and the side surface 7f are disposed so as to face each other in the third direction D3. The side surface 7d and the side surface 7f extend over the main surface 2c of the element body 2 and the bottom surface 7b. The side surface 7d and the side surface 7f extend along the second direction D2. The side surface 7d and the side surface 7f also extend in the first direction D1 (depth direction). The side surface 7d and the side surface 7f are parallel to the side surfaces 2e and 2f. The side surface 7g is a curved surface. The side surface 7g extends over the end surface 2a of the element body 2 and the bottom surface 7a. The side surface 7h is a curved surface. The side surface 7h extends over the main surface 2c of the element body 2 and the bottom surface 7b.

The recessed portion 8 is provided on the end surface 2b side of the element body 2. The recessed portion 8 is a space recessed inward from the outer surface of the element body 2. The recessed portion 8 has a shape corresponding to the shape of the terminal electrode 5. In the present embodiment, the recessed portion 8 has an L shape when viewed from the third direction D3. The recessed portion 8 is defined by bottom surfaces 8a and 8b and side surfaces 8c, 8d, 8e, 8f, 8g, and 8h. The bottom surface 8a extends along the first direction D1 and the third direction D3. The bottom surface 8a is parallel to the end surfaces 2a and 2b. The bottom surface 8b extends along the second direction D2 and the third direction D3. The bottom surface 8b is parallel to the main surfaces 2c and 2d.

The side surface 8c and the side surface 8e are disposed so as to face each other in the third direction D3. The side surface 8c and the side surface 8e extend over the end surface 2b of the element body 2 and the bottom surface 8a (extend along the depth direction of the recessed portion 8). The side surface 8c and the side surface 8e extend along the first direction D1. The side surface 8c and the side surface 8e also extend in the second direction D2. The side surface 8c and the side surface 8e are parallel to the side surfaces 2e and 2f. The side surface 8d and the side surface 8f are disposed so as to face each other in the third direction D3. The side surface 8d and the side surface 8f extend over the main surface 2c of the element body 2 and the bottom surface 8b. The side surface 8d and the side surface 8f extend along the second direction D2. The side surface 8d and the side surface 8f also extend in the first direction D1. The side surface 8d and the side surface 8f are parallel to the side surfaces 2e and 2f. The side surface 8g is a curved surface. The side surface 8g extends over the end surface 2b of the element body 2 and the bottom surface 8a. The side surface 8h is a curved surface. The side surface 8h extends over the main surface 2c of the element body 2 and the bottom surface 8b.

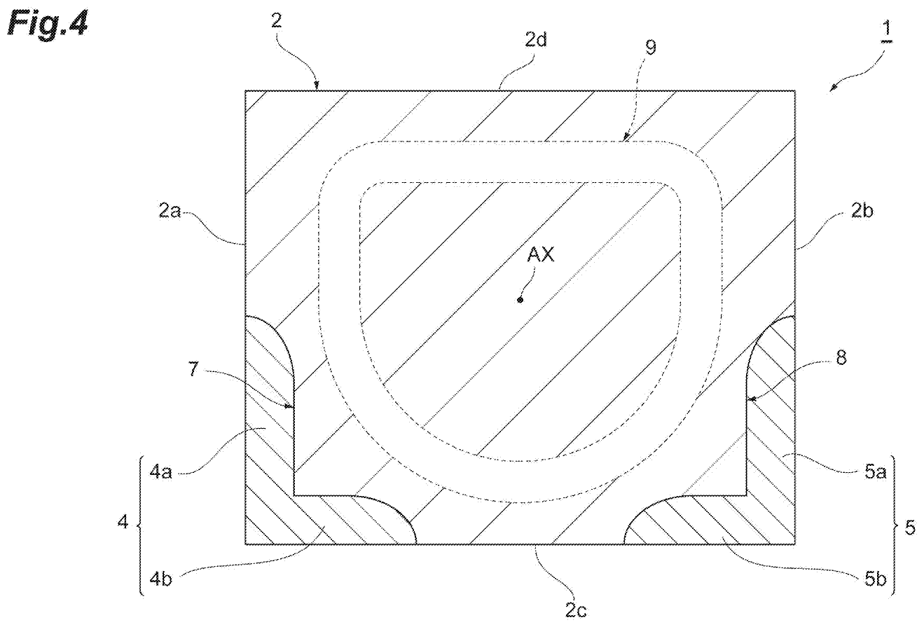

As illustrated in FIG. 4, each of the terminal electrodes 4 and 5 is embedded in the element body 2. The terminal electrode 4 is disposed on the end surface 2a side of the element body 2. The terminal electrode 4 is disposed in the recessed portion 7 of the element body 2. The terminal electrode 4 is in contact with the bottom surfaces 7a and 7b and the side surfaces 7c, 7d, 7e, 7f, 7g, and 7h of the recessed portion 7. The terminal electrode 5 is disposed on the end surface 2b side of the element body 2. The terminal electrode 5 is disposed in the recessed portion 8 of the element body 2. The terminal electrode 5 is in contact with the bottom surfaces 8a and 8b and the side surfaces 8c, 8d, 8e, 8f, 8g, and 8h. The pair of terminal electrodes 4 and 5 are separated from each other in the second direction D2.

The terminal electrode 4 is disposed over the end surface 2a and the main surface 2c. The terminal electrode 5 is disposed over the end surface 2b and the main surface 2c. In the present embodiment, the surface of the terminal electrode 4 is substantially flush with each of the end surface 2a and the main surface 2c. The surface of the terminal electrode 5 is substantially flush with each of the end surface 2b and the main surface 2c.

The terminal electrode 4 has an L shape when viewed from the third direction D3. The terminal electrode 4 has a plurality of electrode parts 4a and 4b. In the present embodiment, the terminal electrode 4 has a pair of electrode parts 4a and 4b. The electrode part 4a and the electrode part 4b are interconnected in the ridge line portion of the element body 2 and are electrically connected to each other. In the present embodiment, the electrode part 4a and the electrode part 4b are integrally formed. The electrode part 4a extends along the first direction D1. The electrode part 4a has a rectangular shape when viewed from the second direction D2. The electrode part 4b extends along the second direction D2. The electrode part 4b has a rectangular shape when viewed from the first direction D1. Each of the electrode parts 4a and 4b extends along the third direction D3.

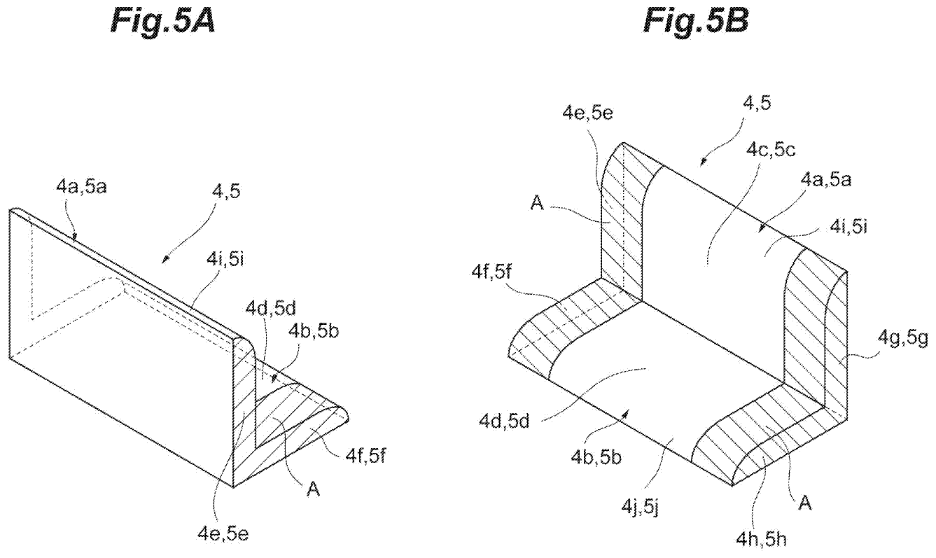

As illustrated in FIGS. 5A and 5B, the terminal electrode 4 has first surfaces 4c and 4d and second surfaces 4e, 4f, 4g, 4h, 4i, and 4j. The first surface 4c is a surface facing (coming into contact with) the bottom surface 7a of the recessed portion 7 of the element body 2. The first surface 4d is a surface facing the bottom surface 7b of the recessed portion 7 of the element body 2. The second surface 4e is a surface facing the side surface 7c of the recessed portion 7 of the element body 2. The second surface 4f is a surface facing the side surface 7d of the recessed portion 7 of the element body 2. The second surface 4g is a surface facing the side surface 7e of the recessed portion 7 of the element body 2. The second surface 4h is a surface facing the side surface 7f of the recessed portion 7 of the element body 2. The second surface 4i is a surface facing the side surface 7g of the recessed portion 7 of the element body 2. The second surface 4j is a surface facing the side surface 7h of the recessed portion 7 of the element body 2.

As illustrated in FIG. 2, the terminal electrode 4 is configured by a plurality of electrode layers 10 and a plurality of electrode layers 11 being stacked. In the present embodiment, the number of the electrode layers 10 is “2” and the number of the electrode layers 11 is “4”. The electrode layer 10 is disposed at a position sandwiching the electrode layer 11 in the third direction D3.

Each electrode layer 10 is provided in a defect portion formed in the insulator layer 6 that corresponds. The defect portion constitutes the recessed portion 7. The electrode layer 10 is formed by conductive paste being fired. The conductive paste contains a metal component and a glass component. The metal component is contained in a conductive material and is, for example, Ag or Pd. The glass component is a compound of elements constituting the element body 2 and is the same component as the glass component contained in the element body 2. The content of the glass component may be appropriately set. Each electrode layer 10 has an L shape when viewed from the third direction D3. The electrode layer 10 has layer parts 10a and 10b. The layer part 10a extends along the first direction D1. The layer part 10b extends along the second direction D2.

Each electrode layer 11 is provided in a defect portion formed in the insulator layer 6 that corresponds. The defect portion constitutes the recessed portion 7. The electrode layer 11 is formed by conductive paste being fired. The conductive paste contains a conductive material. The conductive material is, for example, Ag or Pd. Each electrode layer 11 has an L shape when viewed from the third direction D3. The electrode layer 11 has layer parts 11a and 11b. The layer part 11a extends along the first direction D1. The layer part 11b extends along the second direction D2.

The electrode part 4a is configured by the respective layer parts 10a and 11a of the electrode layers 10 and 11 being stacked. At the electrode part 4a, the layer parts 10a and 11a are integrated to the extent that the boundary between the layer parts 10a and 11a is invisible. The electrode part 4b is configured by the respective layer parts 10b and 11b of the electrode layers 10 and 11 being stacked. At the electrode part 4b, the layer parts 10b and 11b are integrated to the extent that the boundary between the layer parts 10b and 11b is invisible.

As illustrated in FIGS. 5A and 5B, the terminal electrode 4 has a connection region A. The connection region A is a region exposed to the surface of the terminal electrode 4 that faces (comes into contact with) the recessed portion 7 of the element body 2. In the terminal electrode 4, the connection region A is provided on at least the second surfaces 4e, 4f, 4g, 4h, 4i, and 4j facing the side surfaces 7c, 7d, 7e, 7f, 7g, and 7h. In the present embodiment, the connection region A is provided on the first surfaces 4c and 4d facing the bottom surfaces 7a and 7b of the recessed portion 7 and the second surfaces 4e, 4f, 4g, 4h, 4i, and 4j facing the side surfaces 7c, 7d, 7e, 7f, 7g, and 7h. The connection region A is a region where a compound of elements constituting the element body 2 and a metal component are mixed. In other words, the connection region A contains a glass component. In the present embodiment, the electrode layer 10 constitutes the connection region A. The connection region A is provided on the second surfaces 4e, 4f, 4g, 4h, 4i, and 4j positioned in both end portions of the terminal electrode 4 in the third direction D3.

As illustrated in FIG. 4, the terminal electrode 5 has an L shape when viewed from the third direction D3. The terminal electrode 5 has a plurality of electrode parts 5a and 5b. In the present embodiment, the terminal electrode 5 has a pair of electrode parts 5a and 5b. The electrode part 5a and the electrode part 5b are interconnected in the ridge line portion of the element body 2 and are electrically connected to each other. In the present embodiment, the electrode part 5a and the electrode part 5b are integrally formed. The electrode part 5a extends along the first direction D1. The electrode part 5a has a rectangular shape when viewed from the second direction D2. The electrode part 5b extends along the second direction D2. The electrode part 5b has a rectangular shape when viewed from the first direction D1. Each of the electrode parts 5a and 5b extends along the third direction D3.

As illustrated in FIGS. 5A and 5B, the terminal electrode 5 has first surfaces 5c and 5d and second surfaces 5e, 5f, 5g, 5h, 5i, and 5j. The first surface 5c is a surface facing (coming into contact with) the bottom surface 8a of the recessed portion 8 of the element body 2. The first surface 5d is a surface facing the bottom surface 8b of the recessed portion 8 of the element body 2. The second surface 5e is a surface facing the side surface 8c of the recessed portion 8 of the element body 2. The second surface 5f is a surface facing the side surface 8d of the recessed portion 8 of the element body 2. The second surface 5g is a surface facing the side surface 8e of the recessed portion 8 of the element body 2. The second surface 5h is a surface facing the side surface 8f of the recessed portion 8 of the element body 2. The second surface 5i is a surface facing the side surface 8g of the recessed portion 8 of the element body 2. The second surface 5j is a surface facing the side surface 8h of the recessed portion 8 of the element body 2.

As illustrated in FIG. 2, the terminal electrode 5 is configured by a plurality of electrode layers 12 and a plurality of electrode layers 13 being stacked. In the present embodiment, the number of the electrode layers 12 is “2” and the number of the electrode layers 13 is “4”. The electrode layer 12 is disposed at a position sandwiching the electrode layer 13 in the third direction D3.

Each electrode layer 12 is provided in a defect portion formed in the insulator layer 6 that corresponds. The defect portion constitutes the recessed portion 8. The electrode layer 12 is formed by conductive paste being fired. The conductive paste contains a metal component and a glass component. The metal component is contained in a conductive material and is, for example, Ag or Pd. The glass component is a compound of elements constituting the element body 2 and is the same component as the glass component contained in the element body 2. Each electrode layer 12 has an L shape when viewed from the third direction D3. The electrode layer 12 has layer parts 12a and 12b. The layer part 12a extends along the first direction D1. The layer part 12b extends along the second direction D2.

Each electrode layer 13 is provided in a defect portion formed in the insulator layer 6 that corresponds. The defect portion constitutes the recessed portion 8. The electrode layer 13 is formed by conductive paste being fired. The conductive paste contains a conductive material. The conductive material is, for example, Ag or Pd. Each electrode layer 13 has an L shape when viewed from the third direction D3. The electrode layer 13 has layer parts 13a and 13b. The layer part 13a extends along the first direction D1. The layer part 13b extends along the second direction D2.

The electrode part 5a is configured by the respective layer parts 12a and 13a of the electrode layers 12 and 13 being stacked. At the electrode part 5a, the layer parts 12a and 13a are integrated to the extent that the boundary between the layer parts 12a and 13a is invisible. The electrode part 5b is configured by the respective layer parts 12b and 13b of the electrode layers 12 and 13 being stacked. At the electrode part 5b, the layer parts 12b and 13b are integrated to the extent that the boundary between the layer parts 12b and 13b is invisible.

As illustrated in FIGS. 5A and 5B, the terminal electrode 5 has a connection region A. The connection region A is a region exposed to the surface of the terminal electrode 5 that faces (comes into contact with) the recessed portion 8 of the element body 2. In the terminal electrode 5, the connection region A is provided on at least the second surfaces 5e, 5f, 5g, 5h, 5i, and 5j facing the side surfaces 8c, 8d, 8e, 8f, 8g, and 8h. In the present embodiment, the connection region A is provided on the first surfaces 5c and 5d facing the bottom surfaces 8a and 8b of the recessed portion 8 and the second surfaces 5e, 5f, 5g, 5h, 5i, and 5j facing the side surfaces 8c, 8d, 8e, 8f, 8g, and 8h. In the present embodiment, the electrode layer 12 constitutes the connection region A. The connection region A is provided on the second surfaces 5e, 5f, 5g, 5h, 5i, and 5j positioned in both end portions of the terminal electrode 5 in the third direction D3.

As illustrated in FIG. 4, the multilayer coil component 1 is provided with a coil 9 disposed in the element body 2. A coil axis AX of the coil 9 extends along the third direction D3.

As illustrated in FIG. 3, the coil 9 has a first coil conductor 22, a second coil conductor 23, a third coil conductor 24, and a fourth coil conductor 25. The first coil conductor 22, the second coil conductor 23, the third coil conductor 24, and the fourth coil conductor 25 are disposed along the third direction D3 in the order of the first coil conductor 22, the second coil conductor 23, the third coil conductor 24, and the fourth coil conductor 25. The first coil conductor 22, the second coil conductor 23, the third coil conductor 24, and the fourth coil conductor 25 substantially have a shape in which a part of a loop is interrupted and have one end and the other end. The first coil conductor 22, the second coil conductor 23, the third coil conductor 24, and the fourth coil conductor 25 are formed with a predetermined width.

The first coil conductor 22 is positioned in the same layer as one electrode layer 12 and one electrode layer 13. The first coil conductor 22 is connected to the electrode layer 13 via a connecting conductor 26. The connecting conductor 26 is positioned in the same layer as the first coil conductor 22. One end of the first coil conductor 22 is connected to the connecting conductor 26. The connecting conductor 26 is connected to the layer part 13a. The connecting conductor 26 interconnects the first coil conductor 22 and the electrode layer 13. The connecting conductor 26 may be connected to the layer part 13b. The first coil conductor 22 is separated from the electrode layer 11 positioned in the same layer. In the present embodiment, the first coil conductor 22, the connecting conductor 26, and the electrode layer 13 are integrally formed.

The second coil conductor 23 is positioned in the same layer as one electrode layer 11 and one electrode layer 13. The second coil conductor 23 is separated from the electrode layers 11 and 13 positioned in the same layer. The first coil conductor 22 and the second coil conductor 23 are adjacent to each other in the third direction D3 in a state where the insulator layer 6 is interposed between the first coil conductor 22 and the second coil conductor 23. The other end of the first coil conductor 22 and one end of the second coil conductor 23 overlap each other when viewed from the third direction D3.

The third coil conductor 24 is positioned in the same layer as one electrode layer 11 and one electrode layer 13. The third coil conductor 24 is separated from the electrode layers 11 and 13 positioned in the same layer. The second coil conductor 23 and the third coil conductor 24 are adjacent to each other in the third direction D3 in a state where the insulator layer 6 is interposed between the second coil conductor 23 and the third coil conductor 24. The other end of the second coil conductor 23 and one end of the third coil conductor 24 overlap each other when viewed from the third direction D3.

The fourth coil conductor 25 is positioned in the same layer as one electrode layer 12 and one electrode layer 13. The fourth coil conductor 25 is connected to the electrode layer 11 via a connecting conductor 27. The connecting conductor 27 is positioned in the same layer as the fourth coil conductor 25. The other end of the fourth coil conductor 25 is connected to the connecting conductor 27. The connecting conductor 27 is connected to the layer part 11a. The connecting conductor 27 interconnects the fourth coil conductor 25 and the electrode layer 11. The connecting conductor 27 may be connected to the layer part 11b. The fourth coil conductor 25 is separated from the electrode layer 13 positioned in the same layer. In the present embodiment, the fourth coil conductor 25, the connecting conductor 27, and the electrode layer 11 are integrally formed.

The third coil conductor 24 and the fourth coil conductor 25 are adjacent to each other in the third direction D3 in a state where the insulator layer 6 is interposed between the third coil conductor 24 and the fourth coil conductor 25. The other end of the third coil conductor 24 and one end of the fourth coil conductor 25 overlap each other when viewed from the third direction D3.

The first coil conductor 22, the second coil conductor 23, the third coil conductor 24, and the fourth coil conductor 25 are electrically interconnected. The first coil conductor 22, the second coil conductor 23, the third coil conductor 24, and the fourth coil conductor 25 constitute the coil 9. The coil 9 is electrically connected to the terminal electrode 5 through the connecting conductor 26. The coil 9 is electrically connected to the terminal electrode 4 through the connecting conductor 27.

The first coil conductor 22, the second coil conductor 23, the third coil conductor 24, the fourth coil conductor 25, and the connecting conductors 26 and 27 contain a conductive material. The conductive material contains Ag or Pd. The first coil conductor 22, the second coil conductor 23, the third coil conductor 24, the fourth coil conductor 25, and the connecting conductors 26 and 27 are configured as a sintered body of conductive paste containing conductive material powder. Examples of the conductive material powder include Ag powder and Pd powder.

In the present embodiment, the first coil conductor 22, the second coil conductor 23, the third coil conductor 24, the fourth coil conductor 25, and the connecting conductors 26 and 27 contain the same conductive material as each of the terminal electrodes 4 and 5. The first coil conductor 22, the second coil conductor 23, the third coil conductor 24, the fourth coil conductor 25, and the connecting conductors 26 and 27 may contain a conductive material different from the conductive material of each of the terminal electrodes 4 and 5.

The first coil conductor 22, the second coil conductor 23, the third coil conductor 24, the fourth coil conductor 25, and the connecting conductors 26 and 27 are provided in a defect portion formed in the insulator layer 6 that corresponds. The first coil conductor 22, the second coil conductor 23, the third coil conductor 24, the fourth coil conductor 25, and the connecting conductors 26 and 27 are formed by conductive paste positioned in a defect portion formed in a green sheet being fired.

The defect portion formed in the green sheet is formed by, for example, the following process. First, a green sheet is formed by element paste containing the constituent material of the insulator layer 6 and a photosensitive material being applied onto a base material. The base material is, for example, a PET film. The photosensitive material contained in the element paste may be either a negative photosensitive material or a positive photosensitive material and a known photosensitive material can be used. Next, the green sheet is exposed and developed by a photolithography method by means of a mask corresponding to the defect portion, and then the defect portion is formed in the green sheet on the base material. The green sheet in which the defect portion is formed is an element pattern.

The electrode layers 10, 11, 12, and 13, the first coil conductor 22, the second coil conductor 23, the third coil conductor 24, the fourth coil conductor 25, and the connecting conductors 26 and 27 are formed by, for example, the following process.

First, a conductive material layer is formed by conductive paste containing a photosensitive material being applied onto a base material. The photosensitive material contained in the conductive paste may be either a negative photosensitive material or a positive photosensitive material and a known photosensitive material can be used. Next, the conductive material layer is exposed and developed by a photolithography method by means of a mask corresponding to the defect portion, and then a conductor pattern corresponding to the shape of the defect portion is formed on the base material.

The multilayer coil component 1 is obtained by, for example, the following process subsequent to the process described above. A sheet in which the element pattern and the conductor pattern are in the same layer is prepared by the conductor pattern being combined with the defect portion of the element pattern. A predetermined number of the sheets are prepared, a stacked body is obtained by the sheets being stacked, heat treatment is performed on the stacked body, and then a plurality of green chips are obtained from the stacked body. In this process, a green stacked body is cut into chips by means of a cutting machine or the like. As a result, a plurality of green chips having a predetermined size can be obtained. Next, the green chips are fired. The multilayer coil component 1 is obtained as a result of the firing. A plating layer may be formed on the surface of each of the terminal electrodes 4 and 5. The plating layer is formed by, for example, electroplating or electroless plating. The plating layer contains, for example, Ni, Sn, or Au.

As described above, in the multilayer coil component 1 according to the present embodiment, the connection region A where a compound of elements constituting the element body 2 and a metal component are mixed is exposed on the second surfaces 4e, 4f, 4g, 4h, 4i, and 4j of the terminal electrode 4. In addition, the connection region A where a compound of elements constituting the element body 2 and a metal component are mixed is exposed on the second surfaces 5e, 5f, 5g, 5h, 5i, and 5j of the terminal electrode 5. In this manner, in the multilayer coil component 1, the surface of the terminal electrode 4 that comes into contact with the side surfaces 7c, 7d, 7e, 7f, 7g, and 7h of the recessed portion 7 of the element body 2 and the surface of the terminal electrode 5 that comes into contact with the side surfaces 8c, 8d, 8e, 8f, 8g, and 8h of the recessed portion 8 of the element body 2 contain a compound of elements constituting the element body 2, and thus the adhesion strength between the connection region A and the element body 2 is improved. Accordingly, in the multilayer coil component 1, the adhesion strength between the element body 2 and the second surfaces 4e, 4f, 4g, 4h, 4i, and 4j of the terminal electrode 4 and the second surfaces 5e, 5f, 5g, 5h, 5i, and 5j of the terminal electrode 5 is improved. Accordingly, in the multilayer coil component 1, it is possible to suppress the occurrence of peeling at the adhesion part between the side surfaces 7c, 7d, 7e, 7f, 7g, and 7h of the recessed portion 7 of the element body 2 and the terminal electrode 4 and the adhesion part between the side surfaces 8c, 8d, 8e, 8f, 8g, and 8h of the recessed portion 8 and the terminal electrode 5. As a result, peeling of the terminal electrodes 4 and 5 can be suppressed in the multilayer coil component 1.

In the multilayer coil component 1 according to the present embodiment, the connection region A is exposed to the second surfaces 4e, 4f, 4g, and 4h positioned in both end portions of the terminal electrode 4 in the direction in which the plurality of insulator layers 6 are stacked. In this configuration, the adhesion strength between the second surfaces 4e, 4f, 4g, and 4h positioned in both end portions of the terminal electrode 4 and the element body 2 is improved. In addition, the connection region A is exposed to the second surfaces 5e, 5f, 5g, and 5h positioned in both end portions of the terminal electrode 5 in the direction in which the plurality of insulator layers 6 are stacked. In this configuration, the adhesion strength between the second surfaces 5e, 5f, 5g, and 5h positioned in both end portions of the terminal electrode 5 and the element body 2 is improved. Accordingly, peeling of the terminal electrodes 4 and 5 can be further suppressed in the multilayer coil component 1.

In the multilayer coil component 1 according to the present embodiment, the connection region A is exposed to the first surfaces 4c and 4d of the terminal electrode 4. In this configuration, the adhesion strength between the element body 2 and the first surfaces 4c and 4d of the terminal electrode 4 as well as the adhesion between the element body 2 and the second surfaces 4e, 4f, 4g, and 4h is improved. In addition, the connection region A is exposed to the first surfaces 5c and 5d of the terminal electrode 5. In this configuration, the adhesion strength between the element body 2 and the first surfaces 5c and 5d of the terminal electrode 5 as well as the adhesion between the element body 2 and the second surfaces 5e, 5f, 5g, and 5h is improved. Accordingly, peeling of the terminal electrodes 4 and 5 can be further suppressed in the multilayer coil component 1.

### Second Embodiment

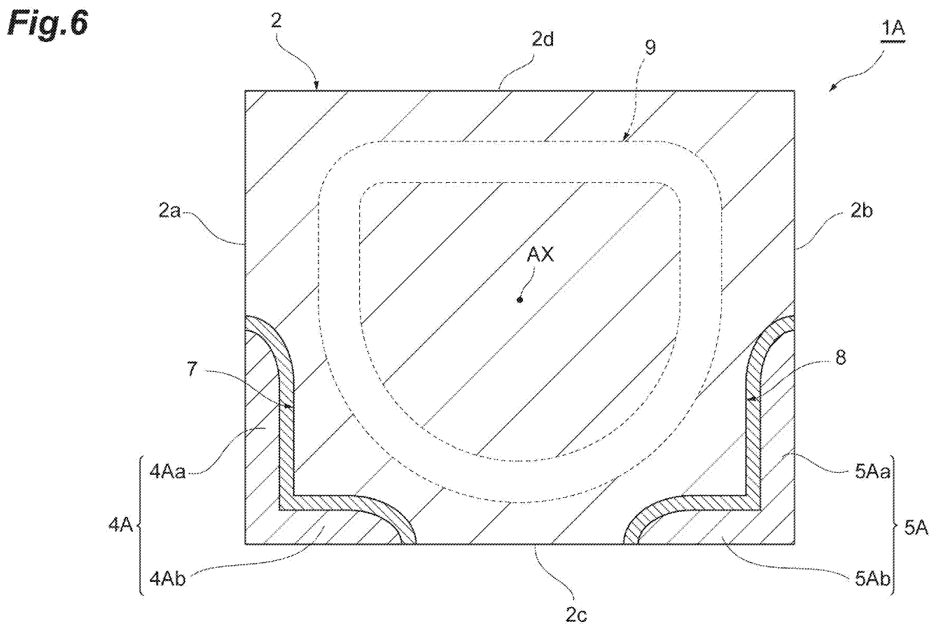

Subsequently, a second embodiment will be described. As illustrated in FIG. 6, a multilayer coil component 1A is provided with the element body 2 having a rectangular parallelepiped shape and a pair of terminal electrodes 4A and 5A.

The terminal electrode 4A has an L shape when viewed from the third direction D3. The terminal electrode 4A has a plurality of electrode parts 4Aa and 4Ab. In the present embodiment, the terminal electrode 4A has a pair of electrode parts 4Aa and 4Ab. The electrode part 4Aa and the electrode part 4Ab are interconnected in the ridge line portion of the element body 2 and are electrically connected to each other. In the present embodiment, the electrode part 4Aa and the electrode part 4Ab are integrally formed. The electrode part 4Aa extends along the first direction D1. The electrode part 4Aa has a rectangular shape when viewed from the second direction D2. The electrode part 4Ab extends along the second direction D2. The electrode part 4Ab has a rectangular shape when viewed from the first direction D1. Each of the electrode parts 4Aa and 4Ab extends along the third direction D3.

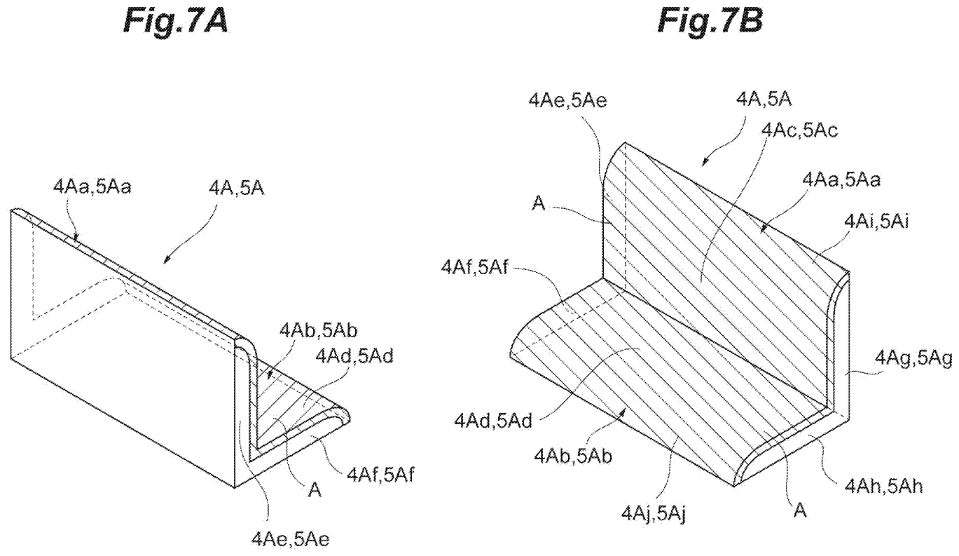

As illustrated in FIGS. 7A and 7B, the terminal electrode 4A has first surfaces 4Ac and 4Ad and second surfaces 4Ae, 4Af, 4Ag, 4Ah, 4Ai, and 4Aj. The first surface 4Ac is a surface facing (coming into contact with) the bottom surface 7a of the recessed portion 7 of the element body 2. The first surface 4Ad is a surface facing the bottom surface 7b of the recessed portion 7 of the element body 2. The second surface 4Ae is a surface facing the side surface 7c of the recessed portion 7 of the element body 2. The second surface 4Af is a surface facing the side surface 7d of the recessed portion 7 of the element body 2. The second surface 4Ag is a surface facing the side surface 7e of the recessed portion 7 of the element body 2. The second surface 4Ah is a surface facing the side surface 7f of the recessed portion 7 of the element body 2. The second surface 4Ai is a surface facing the side surface 7g of the recessed portion 7 of the element body 2. The second surface 4Aj is a surface facing the side surface 7h of the recessed portion 7 of the element body 2.

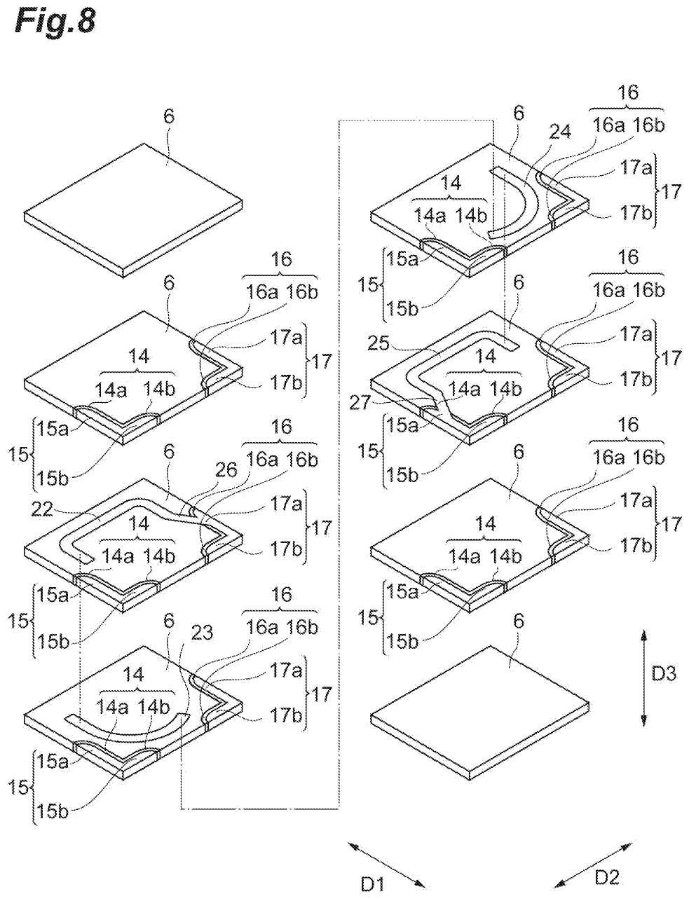

As illustrated in FIG. 8, the terminal electrode 4A is configured by a plurality of electrode layers 14 and a plurality of electrode layers 15 being stacked. In the present embodiment, the number of the electrode layers 14 is “6” and the number of the electrode layers 15 is “6”.

Each electrode layer 14 is provided in a defect portion formed in the insulator layer 6 that corresponds. The defect portion constitutes the recessed portion 7. The electrode layer 15 is formed by conductive paste being fired. The conductive paste contains a metal component and a glass component. The metal component is contained in a conductive material and is, for example, Ag or Pd. The glass component is a compound of elements constituting the element body 2 and is the same component as the glass component contained in the element body 2. Each electrode layer 14 has an L shape when viewed from the third direction D3. The electrode layer 14 has layer parts 14a and 14b. The layer part 14a extends along the first direction D1. The layer part 14b extends along the second direction D2.

Each electrode layer 15 is provided in a defect portion formed in the insulator layer 6 that corresponds. Each electrode layer 15 is positioned in the same insulator layer 6 as each electrode layer 14. The electrode layer 15 is provided in a region outside the electrode layer 14 in the defect portion of the insulator layer 6. The electrode layer 15 is formed by conductive paste being fired. The conductive paste contains a conductive material. The conductive material is, for example, Ag or Pd. Each electrode layer 15 has an L shape when viewed from the third direction D3. The electrode layer 15 has layer parts 15a and 15b. The layer part 15a extends along the first direction D1. The layer part 15b extends along the second direction D2.

The electrode part 4Aa is configured by the respective layer parts 14a and 15a of the electrode layers 14 and 15 being stacked. At the electrode part 4Aa, the layer parts 14a and 15a are integrated to the extent that the boundary between the layer parts 14a and 15a is invisible. The electrode part 4Ab is configured by the respective layer parts 14b and 15b of the electrode layers 14 and 15 being stacked. At the electrode part 4Ab, the layer parts 14b and 15b are integrated to the extent that the boundary between the layer parts 14b and 15b is invisible.

As illustrated in FIGS. 7A and 7B, the terminal electrode 4A has a connection region A. The connection region A is a region exposed to the surface of the terminal electrode 4A that faces (comes into contact with) the recessed portion 7 of the element body 2. In the terminal electrode 4A, the connection region A is provided on at least the second surfaces 4Ae, 4Af, 4Ag, 4Ah, 4Ai, and 4Aj facing the side surfaces 7c, 7d, 7e, 7f, 7g, and 7h. In the present embodiment, the connection region A is provided on the first surfaces 4Ac and 4Ad facing the bottom surfaces 7a and 7b of the recessed portion 7 and the second surfaces 4Ae, 4Af, 4Ag, 4Ah, 4Ai, and 4Aj facing the side surfaces 7c, 7d, 7e, 7f, 7g, and 7h. The connection region A is a region where a compound of elements constituting the element body 2 and a metal component are mixed. In other words, the connection region A contains a glass component. In the present embodiment, the electrode layer 14 constitutes the connection region A.

As illustrated in FIG. 6, the terminal electrode 5A has an L shape when viewed from the third direction D3. The terminal electrode 5A has a plurality of electrode parts 5Aa and 5Ab. In the present embodiment, the terminal electrode 5A has a pair of electrode parts 5Aa and 5Ab. The electrode part 5Aa and the electrode part 5Ab are interconnected in the ridge line portion of the element body 2 and are electrically connected to each other. In the present embodiment, the electrode part 5Aa and the electrode part 5Ab are integrally formed. The electrode part 5Aa extends along the first direction D1. The electrode part 5Aa has a rectangular shape when viewed from the second direction D2. The electrode part 5Ab extends along the second direction D2. The electrode part 5Ab has a rectangular shape when viewed from the first direction D1. Each of the electrode parts 5Aa and 5Ab extends along the third direction D3.

As illustrated in FIGS. 7A and 7B, the terminal electrode 5A has first surfaces 5Ac and 5Ad and second surfaces 5Ae, 5Af, 5Ag, 5Ah, 5Ai, and 5Aj. The first surface 5Ac is a surface facing (coming into contact with) the bottom surface 8a of the recessed portion 8 of the element body 2. The first surface 5Ad is a surface facing the bottom surface 8b of the recessed portion 8 of the element body 2. The second surface 5Ae is a surface facing the side surface 8c of the recessed portion 8 of the element body 2. The second surface 5Af is a surface facing the side surface 8d of the recessed portion 8 of the element body 2. The second surface 5Ag is a surface facing the side surface 8e of the recessed portion 8 of the element body 2. The second surface 5Ah is a surface facing the side surface 8f of the recessed portion 8 of the element body 2. The second surface 5Ai is a surface facing the side surface 8g of the recessed portion 8 of the element body 2. The second surface 5Aj is a surface facing the side surface 8h of the recessed portion 8 of the element body 2.

As illustrated in FIG. 8, the terminal electrode 5A is configured by a plurality of electrode layers 16 and a plurality of electrode layers 17 being stacked. In the present embodiment, the number of the electrode layers 16 is “6” and the number of the electrode layers 17 is “6”.

Each electrode layer 16 is provided in a defect portion formed in the insulator layer 6 that corresponds. The defect portion constitutes the recessed portion 7. The electrode layer 16 is formed by conductive paste being fired. The conductive paste contains a metal component and a glass component. The metal component is contained in a conductive material and is, for example, Ag or Pd. The glass component is a compound of elements constituting the element body 2 and is the same component as the glass component contained in the element body 2. Each electrode layer 16 has an L shape when viewed from the third direction D3. The electrode layer 16 has layer parts 16a and 16b. The layer part 16a extends along the first direction D1. The layer part 16b extends along the second direction D2.

Each electrode layer 17 is provided in a defect portion formed in the insulator layer 6 that corresponds. Each electrode layer 17 is positioned in the same insulator layer 6 as each electrode layer 16. The electrode layer 17 is provided in a region outside the electrode layer 16 in the defect portion of the insulator layer 6. The electrode layer 17 is formed by conductive paste being fired. The conductive paste contains a conductive material. The conductive material is, for example, Ag or Pd. Each electrode layer 17 has an L shape when viewed from the third direction D3. The electrode layer 17 has layer parts 17a and 17b. The layer part 17a extends along the first direction D1. The layer part 17b extends along the second direction D2.

The electrode part 5Aa is configured by the respective layer parts 16a and 17a of the electrode layers 16 and 17 being stacked. At the electrode part 5Aa, the layer parts 16a and 17a are integrated to the extent that the boundary between the layer parts 16a and 17a is invisible. The electrode part 5Ab is configured by the respective layer parts 16b and 17b of the electrode layers 16 and 17 being stacked. At the electrode part 5Ab, the layer parts 16b and 17b are integrated to the extent that the boundary between the layer parts 16b and 17b is invisible.

As illustrated in FIGS. 7A and 7B, the terminal electrode 5A has a connection region A. The connection region A is a region exposed to the surface of the terminal electrode 5A that faces (comes into contact with) the recessed portion 8 of the element body 2. In the terminal electrode 5A, the connection region A is provided on at least the second surfaces 5Ae, 5Af, 5Ag, 5Ah, 5Ai, and 5Aj facing the side surfaces 8c, 8d, 8e, 8f, 8g, and 8h. In the present embodiment, the connection region A is provided on the first surfaces 5Ac and 5Ad facing the bottom surfaces 8a and 8b of the recessed portion 8 and the second surfaces 5Ae, 5Af, 5Ag, 5Ah, 5Ai, and 5Aj facing the side surfaces 8c, 8d, 8e, 8f, 8g, and 8h. The connection region A is a region where a compound of elements constituting the element body 2 and a metal component are mixed. In other words, the connection region A contains a glass component. In the present embodiment, the electrode layer 16 constitutes the connection region A.

As described above, in the multilayer coil component 1A according to the present embodiment, the connection region A where a compound of elements constituting the element body 2 and a metal component are mixed is exposed on the second surfaces 4Ae, 4Af, 4Ag, 4Ah, 4Ai, and 4Aj of the terminal electrode 4A. In addition, the connection region A where a compound of elements constituting the element body 2 and a metal component are mixed is exposed on the second surfaces 5Ae, 5Af, 5Ag, 5Ah, 5Ai, and 5Aj of the terminal electrode 5A. In this manner, in the multilayer coil component 1A, the surface of the terminal electrode 4A that comes into contact with the side surfaces 7c, 7d, 7e, 7f, 7g, and 7h of the recessed portion 7 of the element body 2 and the surface of the terminal electrode 5A that comes into contact with the side surfaces 8c, 8d, 8e, 8f, 8g, and 8h of the recessed portion 8 of the element body 2 contain a compound of elements constituting the element body 2, and thus the adhesion strength between the connection region A and the element body 2 is improved. Accordingly, in the multilayer coil component 1A, the adhesion strength between the element body 2 and the second surfaces 4Ae, 4Af, 4Ag, 4Ah, 4Ai, and 4Aj of the terminal electrode 4A and the second surfaces 5Ae, 5Af, 5Ag, 5Ah, 5Ai, and 5Aj of the terminal electrode 5 is improved. Accordingly, in the multilayer coil component 1A, it is possible to suppress the occurrence of peeling at the adhesion part between the side surfaces 7c, 7d, 7e, 7f, 7g, and 7h of the recessed portion 7 of the element body 2 and the terminal electrode 4A and the adhesion part between the side surfaces 8c, 8d, 8e, 8f, 8g, and 8h of the recessed portion 8 and the terminal electrode 5A. As a result, peeling of the terminal electrodes 4A and 5A can be suppressed in the multilayer coil component 1A.

### Third Embodiment

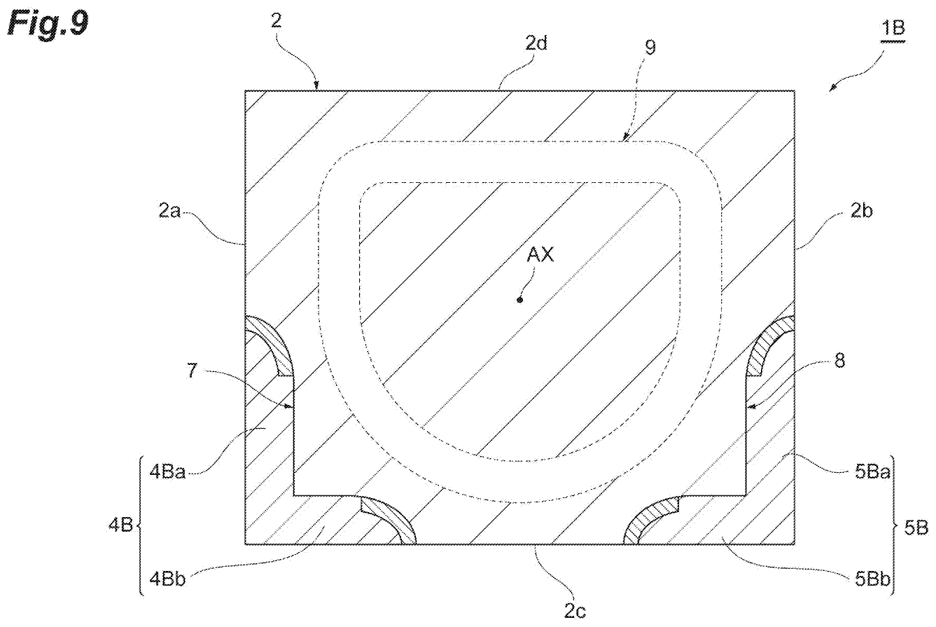

Subsequently, a third embodiment will be described. As illustrated in FIG. 9, a multilayer coil component 1B is provided with the element body 2 having a rectangular parallelepiped shape and a pair of terminal electrodes 4B and 5B.

The terminal electrode 4B has an L shape when viewed from the third direction D3. The terminal electrode 4B has a plurality of electrode parts 4Ba and 4Bb. In the present embodiment, the terminal electrode 4B has a pair of electrode parts 4Ba and 4Bb. The electrode part 4Ba and the electrode part 4Bb are interconnected in the ridge line portion of the element body 2 and are electrically connected to each other. In the present embodiment, the electrode part 4Ba and the electrode part 4Bb are integrally formed. The electrode part 4Ba extends along the first direction D1. The electrode part 4Ba has a rectangular shape when viewed from the second direction D2. The electrode part 4Bb extends along the second direction D2. The electrode part 4Bb has a rectangular shape when viewed from the first direction D1. Each of the electrode parts 4Ba and 4Bb extends along the third direction D3.

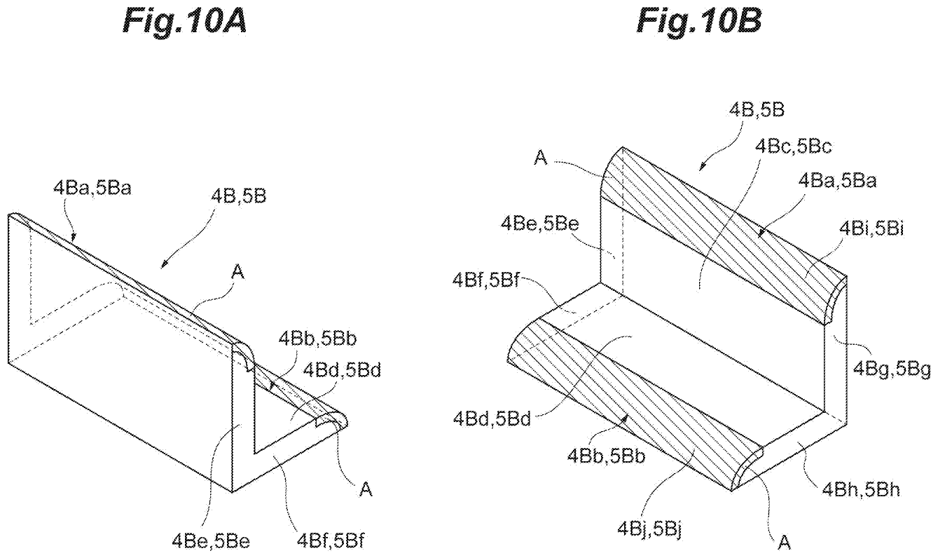

As illustrated in FIGS. 10A and 10B, the terminal electrode 4B has first surfaces 4Bc and 4Bd and second surfaces 4Be, 4Bf, 4Bg, 4Bh, 4Bi, and 4Bj. The first surface 4Bc is a surface facing (coming into contact with) the bottom surface 7a of the recessed portion 7 of the element body 2. The first surface 4Bd is a surface facing the bottom surface 7b of the recessed portion 7 of the element body 2. The second surface 4Be is a surface facing the side surface 7c of the recessed portion 7 of the element body 2. The second surface 4Bf is a surface facing the side surface 7d of the recessed portion 7 of the element body 2. The second surface 4Bg is a surface facing the side surface 7e of the recessed portion 7 of the element body 2. The second surface 4Bh is a surface facing the side surface 7f of the recessed portion 7 of the element body 2. The second surface 4Bi is a surface facing the side surface 7g of the recessed portion 7 of the element body 2. The second surface 4Bj is a surface facing the side surface 7h of the recessed portion 7 of the element body 2.

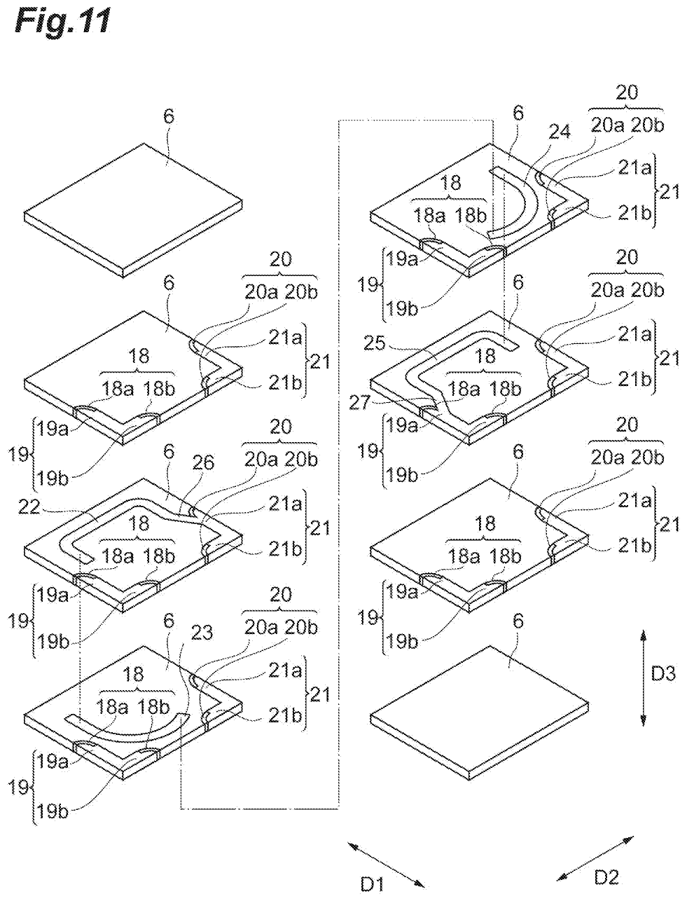

As illustrated in FIG. 11, the terminal electrode 4B is configured by a plurality of electrode layers 18 and a plurality of electrode layers 19 being stacked. In the present embodiment, the number of the electrode layers 18 is “6” and the number of the electrode layers 19 is “6”.

Each electrode layer 18 is provided in a defect portion formed in the insulator layer 6 that corresponds. The defect portion constitutes the recessed portion 7. The electrode layer 18 is formed by conductive paste being fired. The conductive paste contains a metal component and a glass component. The metal component is contained in a conductive material and is, for example, Ag or Pd. The glass component is a compound of elements constituting the element body 2 and is the same component as the glass component contained in the element body 2. The electrode layer 18 has layer parts 18a and 18b. The layer part 18a and the layer part 18b are separated.

Each electrode layer 19 is provided in a defect portion formed in the insulator layer 6 that corresponds. Each electrode layer 19 is positioned in the same insulator layer 6 as each electrode layer 18. The electrode layer 19 is provided in a region outside the electrode layer 18 in the defect portion of the insulator layer 6. The electrode layer 19 is formed by conductive paste being fired. The conductive paste contains a conductive material. The conductive material is, for example, Ag or Pd. Each electrode layer 19 has an L shape when viewed from the third direction D3. The electrode layer 19 has layer parts 19a and 19b. The layer part 19a extends along the first direction D1. The layer part 19b extends along the second direction D2.

The electrode part 4Ba is configured by the respective layer parts 18a and 19a of the electrode layers 18 and 19 being stacked. At the electrode part 4Ba, the layer parts 18a and 19a are integrated to the extent that the boundary between the layer parts 18a and 19a is invisible. The electrode part 4Bb is configured by the respective layer parts 18b and 19b of the electrode layers 18 and 19 being stacked. At the electrode part 4Bb, the layer parts 18b and 19b are integrated to the extent that the boundary between the layer parts 18b and 19b is invisible.

As illustrated in FIGS. 10A and 10B, the terminal electrode 4B has a connection region A. The connection region A is a region exposed to the surface of the terminal electrode 4B that faces (comes into contact with) the recessed portion 7 of the element body 2. In the terminal electrode 4B, the connection region A is provided on at least the second surfaces 4Be, 4Bf, 4Bg, 4Bh, 4Bi, and 4Bj facing the side surfaces 7c, 7d, 7e, 7f, 7g, and 7h. In the present embodiment, the connection region A is provided on the first surfaces 4Bc and 4Bd facing the bottom surfaces 7a and 7b of the recessed portion 7 and the second surfaces 4Be, 4Bf, 4Bg, 4Bh, 4Bi, and 4Bj facing the side surfaces 7c, 7d, 7e, 7f, 7g, and 7h. The connection region A is a region where a compound of elements constituting the element body 2 and a metal component are mixed. In other words, the connection region A contains a glass component. In the present embodiment, the electrode layer 18 constitutes the connection region A.

As illustrated in FIG. 9, the terminal electrode 5B has an L shape when viewed from the third direction D3. The terminal electrode 5B has a plurality of electrode parts 5Ba and 5Bb. In the present embodiment, the terminal electrode 5B has a pair of electrode parts 5Ba and 5Bb. The electrode part 5Ba and the electrode part 5Bb are interconnected in the ridge line portion of the element body 2 and are electrically connected to each other. In the present embodiment, the electrode part 5Ba and the electrode part 5Bb are integrally formed. The electrode part 5Ba extends along the first direction D1. The electrode part 5Ba has a rectangular shape when viewed from the second direction D2. The electrode part 5Bb extends along the second direction D2. The electrode part 5Bb has a rectangular shape when viewed from the first direction D1. Each of the electrode parts 5Ba and 5Bb extends along the third direction D3.

As illustrated in FIGS. 10A and 10B, the terminal electrode 5B has first surfaces 5Bc and 5Bd and second surfaces 5Be, 5Bf, 5Bg, 5Bh, 5Bi, and 5Bj. The first surface 5Bc is a surface facing (coming into contact with) the bottom surface 8a of the recessed portion 8 of the element body 2. The first surface 5Bd is a surface facing the bottom surface 8b of the recessed portion 8 of the element body 2. The second surface 5Be is a surface facing the side surface 8c of the recessed portion 8 of the element body 2. The second surface 5Bf is a surface facing the side surface 8d of the recessed portion 8 of the element body 2. The second surface 5Bg is a surface facing the side surface 8e of the recessed portion 8 of the element body 2. The second surface 5Bh is a surface facing the side surface 8f of the recessed portion 8 of the element body 2. The second surface 5Bi is a surface facing the side surface 8g of the recessed portion 8 of the element body 2. The second surface 5Bj is a surface facing the side surface 8h of the recessed portion 8 of the element body 2.

As illustrated in FIG. 11, the terminal electrode 5B is configured by a plurality of electrode layers 20 and a plurality of electrode layers 21 being stacked. In the present embodiment, the number of the electrode layers 20 is “6” and the number of the electrode layers 21 is “6”.

Each electrode layer 20 is provided in a defect portion formed in the insulator layer 6 that corresponds. The defect portion constitutes the recessed portion 7. The electrode layer 20 is formed by conductive paste being fired. The conductive paste contains a metal component and a glass component. The metal component is contained in a conductive material and is, for example, Ag or Pd. The glass component is a compound of elements constituting the element body 2 and is the same component as the glass component contained in the element body 2. The electrode layer 20 has layer parts 20a and 20b. The layer part 20a and the layer part 20b are separated.

Each electrode layer 21 is provided in a defect portion formed in the insulator layer 6 that corresponds. Each electrode layer 21 is positioned in the same insulator layer 6 as each electrode layer 20. The electrode layer 21 is provided in a region outside the electrode layer 20 in the defect portion of the insulator layer 6. The electrode layer 21 is formed by conductive paste being fired. The conductive paste contains a conductive material. The conductive material is, for example, Ag or Pd. Each electrode layer 21 has an L shape when viewed from the third direction D3. The electrode layer 21 has layer parts 21a and 21b. The layer part 21a extends along the first direction D1. The layer part 21b extends along the second direction D2.

The electrode part 5Ba is configured by the respective layer parts 20a and 21a of the electrode layers 20 and 21 being stacked. At the electrode part 5Ba, the layer parts 20a and 21a are integrated to the extent that the boundary between the layer parts 20a and 21a is invisible. The electrode part 5Bb is configured by the respective layer parts 20b and 21b of the electrode layers 20 and 21 being stacked. At the electrode part 5Bb, the layer parts 20b and 21b are integrated to the extent that the boundary between the layer parts 20b and 21b is invisible.

As illustrated in FIGS. 10A and 10B, the terminal electrode 5B has a connection region A. The connection region A is a region exposed to the surface of the terminal electrode 5B that faces (comes into contact with) the recessed portion 8 of the element body 2. In the terminal electrode 5B, the connection region A is provided on at least the second surfaces 5Be, 5Bf, 5Bg, 5Bh, 5Bi, and 5Bj facing the side surfaces 8c, 8d, 8e, 8f, 8g, and 8h. In the present embodiment, the connection region A is provided on the first surfaces 5Bc and 5Bd facing the bottom surfaces 8a and 8b of the recessed portion 8 and the second surfaces 5Be, 5Bf, 5Bg, 5Bh, 5Bi, and 5Bj facing the side surfaces 8c, 8d, 8e, 8f, 8g, and 8h. The connection region A is a region where a compound of elements constituting the element body 2 and a metal component are mixed. In other words, the connection region A contains a glass component. In the present embodiment, the electrode layer 20 constitutes the connection region A.

As described above, in the multilayer coil component 1B according to the present embodiment, the connection region A where a compound of elements constituting the element body 2 and a metal component are mixed is exposed on the second surfaces 4Be, 4Bf, 4Bg, 4Bh, 4Bi, and 4Bj of the terminal electrode 4B. In addition, the connection region A where a compound of elements constituting the element body 2 and a metal component are mixed is exposed on the second surfaces 5Be, 5Bf, 5Bg, 5Bh, 5Bi, and 5Bj of the terminal electrode 5B. In this manner, in the multilayer coil component 1B, the surface of the terminal electrode 4B that comes into contact with the side surfaces 7c, 7d, 7e, 7f, 7g, and 7h of the recessed portion 7 of the element body 2 and the surface of the terminal electrode 5B that comes into contact with the side surfaces 8c, 8d, 8e, 8f, 8g, and 8h of the recessed portion 8 of the element body 2 contain a compound of elements constituting the element body 2, and thus the adhesion strength between the connection region A and the element body 2 is improved. Accordingly, in the multilayer coil component 1B, the adhesion strength between the element body 2 and the second surfaces 4Be, 4Bf, 4Bg, 4Bh, 4Bi, and 4Bj of the terminal electrode 4B and the second surfaces 5Be, 5Bf, 5Bg, 5Bh, 5Bi, and 5Bj of the terminal electrode 5B is improved. Accordingly, in the multilayer coil component 1B, it is possible to suppress the occurrence of peeling at the adhesion part between the side surfaces 7c, 7d, 7e, 7f, 7g, and 7h of the recessed portion 7 of the element body 2 and the terminal electrode 4B and the adhesion part between the side surfaces 8c, 8d, 8e, 8f, 8g, and 8h of the recessed portion 8 and the terminal electrode 5B. As a result, peeling of the terminal electrodes 4B and 5B can be suppressed in the multilayer coil component 1B.

Although the embodiments of the present invention have been described above, the present invention is not necessarily limited to the above-described embodiments and various changes can be made without departing from the gist of the present invention.

In the above-described embodiment, a form in which the connection region A is a region where a glass component as a compound of elements constituting the element body 2 and a metal component are mixed has been described as an example. However, the compound of elements constituting the element body 2 is not limited to the glass component. The compound may be any element constituting the element body 2.

In the above-described embodiment, a form in which the connection region A is exposed to a part of the first surfaces 4c and 4d and the second surfaces 4e, 4f, 4g, 4h, 4i, and 4j of the terminal electrode 4 in the multilayer coil component 1 has been described as an example. However, the connection region A may be exposed to the entire first surfaces 4c and 4d and second surfaces 4e, 4f, 4g, 4h, 4i, and 4j of the terminal electrode 4. The same applies to the terminal electrode 5. In addition, the same applies to the multilayer coil components 1A and 1B.

In the above-described embodiment, a form in which the coil 9 has the first coil conductor 22, the second coil conductor 23, the third coil conductor 24, and the fourth coil conductor 25 has been described as an example. However, the number of coil conductors constituting the coil 9 is not limited to the above-described value.

In the above-described embodiment, a form in which the coil axis AX of the coil 9 extends along the third direction D3 has been described as an example. However, the coil axis AX of the coil 9 may extend along the first direction D1. In this case, the direction in which the plurality of insulator layers 6 are stacked coincides with the first direction D1.

In the above-described embodiment, a form in which the terminal electrode 4 has the electrode part 4a and the electrode part 4b has been described as an example. However, the terminal electrode 4 may have only the electrode part 4a or may have only the electrode part 4b. Likewise, the terminal electrode 5 may have only the electrode part 5a or may have only the electrode part 5b. The same applies to the terminal electrodes 4A, 4B, 5A, and 5B.

What is claimed is:

1. A multilayer coil component comprising:
an element body having a plurality of stacked insulator layers and having an outer surface provided with a recessed portion;
a coil disposed in the element body; and
a terminal electrode connected to the coil and disposed in the recessed portion, wherein
the recessed portion is defined by a bottom surface and a side surface extending in a depth direction of the recessed portion over the outer surface and the bottom surface,
the terminal electrode has a first surface facing the bottom surface and a second surface facing the side surface, and
a connection region where a compound of elements constituting the element body and a metal component are mixed is exposed to the second surface.

2. The multilayer coil component according to claim 1, wherein the connection region is exposed to the second surface positioned in both end portions of the terminal electrode in a direction in which the plurality of insulator layers are stacked.

3. The multilayer coil component according to claim 1, wherein the connection region is exposed to the first surface.

4. The multilayer coil component according to claim 2, wherein the connection region is exposed to the first surface.
